(19) United States
(12) Patent Application Publication
(10) Pub. No.: US 2009/0312875 A1
(43) Pub. Date: Dec. 17, 2009

(54) METHOD AND AN ARRANGEMENT FOR DAMPENING VIBRATIONS IN A MAST STRUCTURE

(76) Inventors: Lasse Lehtonen, Vantaa (FI); Kyösti Sarkkinen, Jarvenpaa (FI); Janne Polvilampi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/309,127

(22) PCT Filed: Jul. 12, 2006
(86) PCT No.: PCT/FI2006/000247

§ 371 Date: Jan. 6, 2009

(51) Int. Cl. G05B 15/00

(52) U.S. Cl. 700/280

(57) ABSTRACT

A method and an arrangement for dampening vibration in a mast structure of a mast truck where the critical characteristics of the mast structure and/or of the vibration are measured, computed, measured and computed or at least some of the characteristics are fed to the computing system in advance, the lowest natural frequency (ωₙ) of the mast structure and/or the phase of the vibration is computed from the collected data or determined directly from the mast structure, the order for movement is obtained from driver or master system, the critical characteristics are fed to the computing system, the movement guidance to the speed controller is generated from above mentioned characteristics of the vibration, the order for movement is divided at least two parts (impulses I), and the actuator is controlled with speed controller for moving the truck or load in the truck according to the order for movement.

### TECHNICAL FIELD

The invention relates to a method and an arrangement for dampening vibration in a mast structure. More specifically the invention relates to active dampening of vibration in mast trucks.

### BACKROUND OF THE INVENTION

Mast trucks are used for lifting up persons or load. The mast truck has two main components: body of the truck and telescopic lifting device (a mast). The mast is connected at it's lower part to the body of the truck. In case when the load has to be moved for example to the shelf the load must be moved to desired direction. There are three possibilities to move load to the shelf. First choice is to drive the whole truck itself forward. Second choice is to tilt the mast forward. Third choice is to use special device (a sledge) designed to reach out to the shelf. In all mentioned cases the load is moved back or forth in the trucks driving direction. On the other hand the load can also be moved sideways by changing the position of the forks or moving the sledge sideways.

When the truck is moved or the load is moved these movements are awakening vibration in the mast structure. This vibration becomes more intense when the distance between the masts connection point and the load grows. This distance could easily be even over ten meters. This vibration is characterised by the masts structural characteristics, such as mass and rigidity. These characteristics define the natural frequency of the mast structure.

When the mass is moved (generation of the impulse) at the upper end of the truck mast the most critical vibration frequency is the lowest natural frequency. When the mass is mounted to the mast and deflected from its centre position and released the mass starts to vibrate at a frequency characterised by the mass and spring rate. The damping coefficient determines the rate how fast the vibration dies out.

The vibration in truck mast is most disturbing when the load is heavy and it is lifted to very high positions. This means that in this type of cases the natural frequency is very low, typically around 0.3 Hz. This type of vibration is clearly visible and has large movement at the upper end of the mast and also this type of vibration is dies out very slowly, because the damping coefficient is affected only with the structures own dampening capabilities and air resistance.

The vibration in mast trucks is conventionally tried to be controlled with structural options and solutions. Used techniques are for example stiffening the mast structure, limiting the maximum speed of movement or avoiding rapid accelerations and deceleration.

On the other hand various passive systems have been developed to damp the vibration of mast structures. The vibrating structure is in those cases separated from the body of the truck with a damper or damping material. This type of solutions are operating with means of diminishing the influence of the awakening impulse or by eliminating out the vibration energy from the structure. Another passive solution is also a dynamic mass-damper, which vibrates at the opposing phase of vibration than the structure itself. The mass-damper is always adjusted to operate in certain frequency and when the natural frequency of the structure is changed (different mass at the end of the truck mast) the mass-damper becomes less effective. In worst scenario the mass-damper can become a device which actually strengthens the amplitude of the vibration.

In documents EP 0 427 001 A1, DE 40 19 075 A1 and GB 2 379 434 A are presented previously mentioned solutions.

In EP 0 427 001 A1 and DE 40 19 075 A1 are presented passive damping systems with separate dampers assembled between the truck mast and the truck body. Systems are quite similar, only the positioning of the damper system varies. In GB 2 379 434 A is presented a mass-damper system for controlling the vibration of the structure.

### SUMMARY OF THE INVENTION

The object of the invention is to produce a method and an arrangement that are effectively damping the vibration of mast trucks mast or even preventing the appearance of the vibration.

This object is achieved with an active damping arrangement having features described in the independent claim 1 and with a method having features described in independent claim 7.

The idea of the invention is to bring additional energy to the vibrating system at different phase of the vibration to even out the vibration on contrary to the prior art systems that are trying to reduce the energy with dampers or such.

### BRIEF DESCRIPTION OF THE DRAWINGS

In the following the exemplary embodiments of the invention are described more specifically with reference to a drawing, wherein

FIGS. 1a-b are showing different possibilities for the generation of the impulse,

FIG. 2 shows three lowest natural frequencies that can be generated in the mast structure,

FIGS. 3 a-b are showing two prior art methods for passive systems,

FIG. 4 shows the impulse and counter-impulse in time/position scale, and

FIG. 5 shows the diagram of the method for dampening the vibration according to the invention.

### DESCRIPTION OF PREFERRED EMBODIMENTS

In FIGS. 1a-b are described the different possibilities for the generation of the impulse (one degree of freedom). In FIG. 1a are presented four different movements that can generate vibration to the mast structure 1 of the mast truck 2. All these movements are in the moving direction of the truck 2. Arrow 3 is describing the driving movement of the truck 2. The movement can be forward or backward. Arrow 4 describes the movement of the mast structure 1 in relation to the truck body 5. Also this movement can be either forward or backward. Arrow 6 is describing the tilting movement of the mast structure 1 in relation to the truck body 5. The mast structure 1 can also be tilted either forward or backward. Arrow 7 is describing the movement of the forks 8 or a sledge that is carrying the load 9.

In FIG. 1b are another possibility to generate vibration to the structure. In this case the load 9 is moved in transversal direction according to an arrow 10 compared to the moving direction of the truck 2. This movement is caused with moving forks 8 or a sledge.

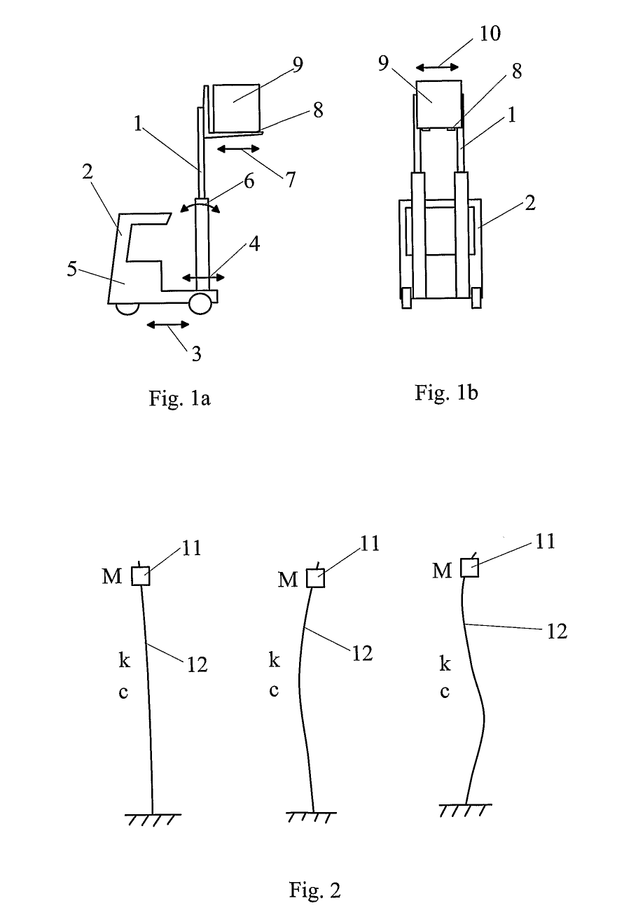

In FIG. 2 are described three lowest natural frequencies (ωₙ) that can be generated in the mast structure. Mass (load) is described as a square 11 at the top of the mast 12. Also the mass of the mast 12 has to be included to the calculations of the natural frequencies of the structure. Another characteristics that is influencing to the natural frequencies is the stiffness of the mast structure (spring rate=k) and the damping constant (c) (partly build in the structure and also including air drag). The most important frequency is the lowest natural frequency (described left).

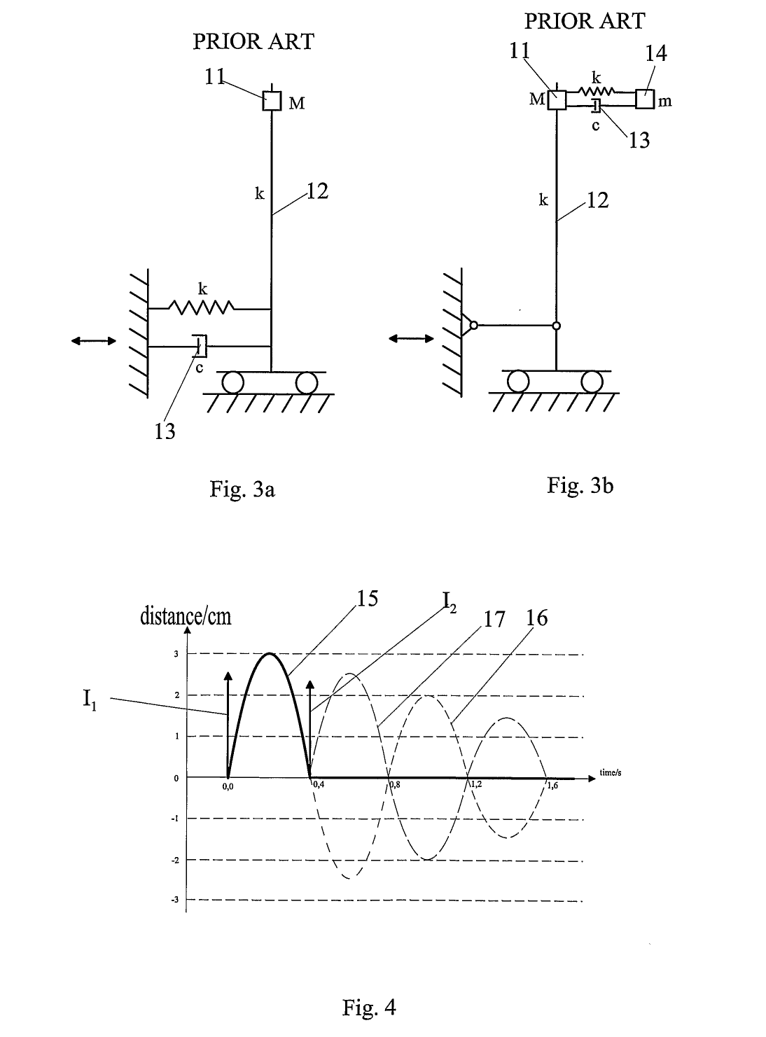

In FIGS. 3a-b are described two passive prior art methods for controlling the vibrations. In FIG. 3a the mast structure 12 is isolated and the vibrations are damped with a damper 13. Load 11 is situated at the top of the mast 12. In FIG. 3b is presented schematically a dynamic mass damper system. The balancing mass (m) 14 and the damper 14 are situated also to the top of the mast. This solution is fixed to certain mass (M) and to certain height of the mast 12. In both figures M is a mass, c is a damping factor and k is a spring factor.

Also semi-active methods are known, where a specific characteristics of the system can be adjusted. Such characteristics are for example viscosity of the damper, rigidity of the joint or friction.

In FIG. 4 is presented active method for controlling vibration in a structure. X-axis presents time (seconds) and Y-axis presents position (centimetres). At time 0.0 seconds the structure has impact type impulse I₁, which activates the structure to vibrate according to curve 15. The position of the structures measuring point moves nearly 3 centimetres in 0.2 seconds time and after that the measuring point starts to move back to the starting point (zero movement). After the half wavelengths time (here 0.4 s) the structure has reached again its original position and is having another impulse I₂ (a counter impulse). If the rate of the impulse I₂ and the half wavelength is calculated correctly the second impulse I₂ stops the vibration of the structure. The dashed lines 16 and 17 are demonstrating the movements generated by the impulses (I₁ and I₂) if they were affecting alone in the structure. In this example the affecting time of the impulse is very short (hit type impulse).

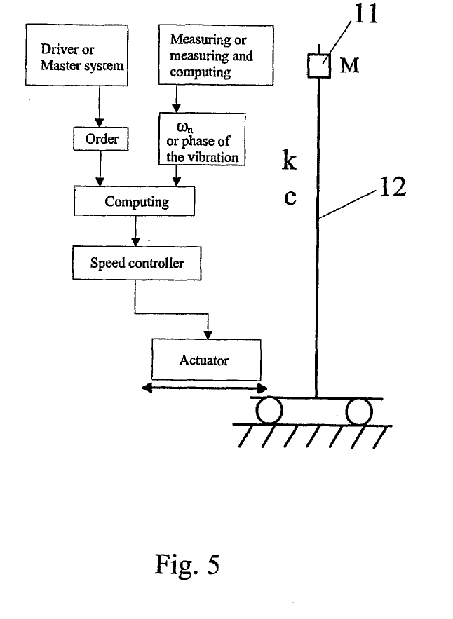

In FIG. 5 is presented the diagram of the method and of the arrangement for dampening the vibration according to the invention. The basic idea of the invention is to divide the order of movement to at least two impulses that are affecting the mast structure. The first impulse causes the mast structure to vibrate and the second (and possible other later impulses) are dampening the generated vibration. There are many possible mathematical solutions to create such formulas that are counting the magnitudes of the impulses, the affecting time of the impulse and the time gaps between the impulses. This calculation can be done so that at once a part of the order of the movement is executed immediately when the order of the movement is received and another part after calculated time period. This guidance to the next moment of time and to the future are calculated continuously. Another possibility is that the calculation can be done as a continuous process where the affecting impulse is calculated for every predetermined time period for next moment of time and has feedback data of for example the movement of the tip of the mast. The position of the tip of the mast can be calculated if the given order for movement and natural frequency are known or measured or measured and calculated by position sensor.

Both mentioned solutions are producing at least two impulses to the mast structure.

The method has following steps:
critical characteristics of the mast structure 12 and/or of the vibration are measured, computed, measured and computed or at least some of the characteristics are fed to the computing system in advance,
the lowest natural frequency (ωₙ) of the mast structure 12 and/or of the vibration is computed from the collected data or determined directly from the mast structure,
the order for movement is obtained from driver or master system (if automated storage with automated trucks),
the critical characteristics are fed to the computing system,
the movement guidance to the speed controller is generated from above mentioned characteristics of the vibration,
the order for movement is divided at least two parts (impulses I),
the actuator is controlled with speed controller for moving the truck or load in the truck according to the order for movement.

The arrangement according to the invention has following features:
means for determining directly the natural frequency or the phase of the vibration or means for determining the characteristics for computing the natural frequency (ωₙ) or the phase of the vibration of the mast structure,
means for determining the order for the movement from the driver or the master system,
means for computing the ratio of division and a time between the impacts of the impulses and/or the phase of the vibration generated by the order of the movement, and
means for computing the movement guidance to the speed controller and delivering the guidance to the actuator.

The measuring of the critical characteristics of the mast structure can be done with sensors that are measuring the amount of the load that is lifted, the height of the load (length of the mast). Some of these characteristics can be calculated from measured values and some of these characteristics can also be fed in advance in the computing system, such as mass distribution of the mast structure, rigidity of the mast, etc.

The measuring of the phase of the vibration directly from the structure can be done by using different type of sensors such as strain gauges, acceleration sensors, speed sensors or position sensors. This embodiment is minimising the calculation process. The measurement of the phase of the vibration can also be done from the hydraulic system with pressure sensor.

Another possibility is to measure the amount of the mass (load), height of the mass (lifting height) and then compute the phase of the vibration based on the information about the changes in the natural frequencies.

The active dampening of the vibration (lowest natural frequency of the structure) in mast structure is done by modifying the given command for moving the truck or the load. In practice this means that given speed command is not carried out straight-forward, but so that the movement is decelerated or accelerated in right phases of the vibration so that the vibration is damped.

One possible solution is to divide the impulse (acceleration) into two parts and carry out the second (later) part of the impulse (acceleration) in phase of the reversing movement of the vibration and generate by this way a second impulse (counter impulse) to the structure. By this arrangement the vibration dies out as is described in FIG. 4. The time between the two impulses is counted from the wavelength of the natural frequency. The magnitude of the impulses (ratio of division) and the time of execution and the affecting time of the impulse are determined from the characteristics of the vibrating structure and from the order for movement.

Another possibility is to divide the impulse (acceleration) into multiple parts and by this way smoothen up the acceleration (moving of the truck or load) and affect the later parts of the vibration. With the length of the time period can be affected to the smoothness of the movement, the longer the time period is the smoother the movement is.

Yet another possibility is to calculate new guiding parameters for every following predetermined time period. In the computer there is a formula for the movement of the tip of the mast and for order for speed of the movement. To this formula can be entered for example the desired damping factor, such as 70%. (in undamped mast structures the damping factor is about 2%) instead of trying to eliminate the whole vibration at once. Also the movement of the tip of the mast can be determined directly with a position sensor and be entered to the formula with desired damping factor.

In this case the instructions to the actuator are calculated for every following predetermined time period. The formula is generated so that it is generating counter impulse to the structure for dampening the vibration but on the other hand is directing the instructions to the smoother direction, because one of the guiding factors is damping factor (70%).

The present invention may me embodied in other specific forms without departing from its spirit or essential characteristics. The described embodiments are to be considered in all respect only as illustrative and not restrictive. The scope of the invention is, therefore, indicated by the appending claims rather than by the foregoing description. All changes that come within the meaning and range of equivalency of the claims are to be embraced within their scope.

1. A method for dampening or preventing a vibration of a mast structure of a mast truck, wherein
critical characteristics of the mast structure and/or of the vibration are measured, computed, measured and computed or optionally some of the characteristics are fed to a computing system in advance,
the lowest natural frequency (ωₙ) of the mast structure and/or the phase of the vibration is computed from the collected data or determined directly from the mast structure,
the order for movement is obtained from a driver or master system,
the critical characteristics are fed to the computing system,
the movement guidance to a speed controller is generated from above mentioned characteristics of the vibration,
the order for movement is divided at least into two parts (impulses I), and
an actuator is controlled with the speed controller for moving the truck or load in the truck according to the order for movement.

2. The method according to claim 1, wherein the ratio of division of the impulses, the affecting time of the impulses, the time between the impacts of the impulses are determined from the computed or measured natural frequency (ωₙ) and/or phase of the vibration and from the order of the movement.

3. The method according to claim 1, wherein the calculation of the impulses and the guidance to the speed controller is a continuous process, where the affecting impulse is calculated as a continuous process from the order of the movement, from the natural frequency (ωₙ) and/or from the phase of the vibration for every predetermined time period.

4. The method according to claim 1, wherein the critical characteristics of the mast structure are measured with strain gauge(s), acceleration sensor(s), speed sensor(s) and/or position sensor(s).

5. The method according to claim 1, wherein the critical characteristics of the mast structure are measured from a hydraulic system of the mast truck with a pressure sensor(s).

6. The method according to claim 1, wherein the phase of the vibration of the mast structure is obtained by calculating it from the height of the load, magnitude of the load and changes caused by the load in the natural frequency.

7. The method according to claim 1, wherein the phase of the vibration of the mast structure is obtained directly from the structure by using strain gauge(s), acceleration sensor(s), speed sensor(s) and/or position sensor(s).

8. The method according to claim 1, wherein the natural frequency (ωₙ) of the mast structure is calculated from the height of the load, magnitude of the load and changes caused by the load in the natural frequency.

9. The method according to claim 1, wherein the natural frequency (ωₙ) of the mast structure is obtained by measuring the vibration by using strain gauge(s), acceleration sensor(s), speed sensor(s) and/or position sensor(s).

10. The method according to claim 3, wherein the guidance to the speed controller is computed continuously for every predetermined time period and affected also with a desired damping factor.

11. An arrangement for dampening or preventing a vibration of a mast structure of a mast truck, wherein the arrangement comprises:
means for determining directly the natural frequency (ωₙ) or the phase of the vibration or means for determining the characteristics for computing the natural frequency (ωₙ) or the phase of the vibration of the mast structure,
means for determining the order for a movement from the driver or the master system
means for computing value of the order for movement at different phases of the vibration, and
means for computing the movement guidance to a speed controller and delivering the guidance to the actuator for moving the truck according to the order for movement.

12. The arrangement according to claim 11, wherein the means for determining the characteristics of vibration of the mast structure are strain gauge(s), acceleration sensor(s), speed sensor(s), position sensor(s) and/or pressure sensor(s).

13. A mast truck having an arrangement for dampening the vibration of the mast structure according to claim 11.

14. A mast truck having an arrangement for dampening the vibration of the mast structure according to claim 12.
